(19) United States
(12) Patent Application Publication
(10) Pub. No.: US 2026/0316720 A1
(43) Pub. Date: Oct. 15, 2026

(54) ANTI-THEFT IMMOBILIZER SYSTEM AND METHOD FOR DETECTING TAMPERING OR UNAUTHORIZED USE OF A VEHICLE

(71) Applicant: Jesse Loiselle, Granby (CA)

(72) Inventors: Jesse Loiselle, Granby (CA); Guillaume Savoie-Lavigueur, Coteau-du-lac (CA)

(21) Appl. No.: 19/712,976

(22) Filed: Jun. 18, 2026

Related U.S. Application Data
(63) Continuation-in-part of application No. 19/010,592, filed on Jan. 6, 2025.
(60) Provisional application No. 63/683,814, filed on Aug. 16, 2024.

(51) Int. Cl. B60R 25/34; B60R 25/01; B60R 25/10; B60R 25/104; B60R 25/24; B60R 25/40

(52) U.S. Cl. CPC B60R 25/34; B60R 25/01; B60R 25/1001; B60R 25/104; B60R 25/245; B60R 25/403

(57) ABSTRACT

An anti-theft immobilizer for a vehicle. In operation, the anti-theft immobilizer is provided as an intermediary between a battery terminal and a battery cable. The anti-theft immobilizer is operative for disconnecting the battery terminal from the battery cable when an attempted theft is detected by opening a switch provided between the battery terminal and the battery cable.

### CROSS-REFERENCE TO RELATED APPLICATIONS

This application is a continuation-in-part of U.S. patent application Ser. No. 19/010,592, filed Jan. 6, 2025, which is incorporated by reference in its entirety.

Said application Ser. No. 19/010,592 claims the benefit of U.S. Provisional Application No. 63/683,814, filed Aug. 16, 2024, which is also incorporated by reference in its entirety.

### TECHNICAL FIELD

The present invention relates to the field of vehicles, and is more particularly concerned with a vehicle immobilizer.

### BACKGROUND

Vehicle immobilizers are used to prevent unauthorized use of a vehicle by preventing the vehicle's onboard battery from providing enough power to start the vehicle. Typically, this action is performed by preventing the relatively large current required to operate the starter of a combustion engine from reaching the starter. However, a similar action can be performed even in some electric vehicles, as often the onboard electronics required to operate the vehicle in such electric vehicles is provided by a 12V battery, and not by the higher voltage battery used to power the vehicle's electric motor.

One may wish to install an aftermarket immobilizer in a vehicle, either because the vehicle is not provided with one by its manufacturer, or because an already present one is considered inadequate. Due to the need to interface with the high current electrical system of the vehicle, such aftermarket immobilizers are typically installed by specialized technicians. This increases the costs related to the immobilizer, as one needs to pay the technician's work, and is detrimental to online sales, as the end user still requires to hire the technician, even if the immobilizer has been bought through an e-commerce platform, or through a more conventional commerce.

Against this background, there exists a need in the industry to provide novel vehicle immobilizers. An object of the present invention is to provide such immobilizers.

### SUMMARY

In a broad aspect, there is provided an anti-theft immobilizer for a vehicle, the vehicle including an onboard battery having first and second battery terminals usable to provide power to the vehicle through first and second battery cables when the latter are secured respectively to the first and second battery terminals, the anti-theft immobilizer comprising: an enclosure; a first immobilizer terminal provided inside the enclosure for securing the anti-theft immobilizer to the first battery terminal; a second immobilizer terminal provided outside of the enclosure for securing the first battery cable thereto; a switch between the first and second immobilizer terminals and configurable between open and closed configurations, wherein, in the closed configuration, the first and second immobilizer terminals are electrically connected to each other so that an electric current can flow therebetween through the switch, and, in the open configuration, the first and second immobilizer terminals are electrically isolated from each other so that the electric current is prevented from flowing therebetween through the switch; and a controller for configuring the switch between the open and closed configurations, the controller including a theft sensor operative for detecting an attempted theft of the vehicle, the controller being operable for selectively opening the switch when the attempted theft is detected by the theft sensor after the anti-theft immobilizer has been armed. In operation, the anti-theft immobilizer is provided as an intermediary between the first battery terminal and the first battery cable.

There may also be provided an anti-theft immobilizer wherein the anti-theft immobilizer is electrically disconnected from the second battery terminal and includes an immobilizer power source distinct from the onboard battery for powering the anti-theft immobilizer.

There may also be provided an anti-theft immobilizer wherein the second immobilizer terminal is pivotable at least part way around the enclosure.

There may also be provided an anti-theft immobilizer wherein the first immobilizer terminal is configurable between terminal locked and unlocked configurations in which the first immobilizer terminal is respectively locked to and removable from the first battery terminal.

There may also be provided an anti-theft immobilizer wherein the first immobilizer terminal includes a terminal actuator for selectively moving the first immobilizer terminal between the terminal locked and unlocked configurations.

There may also be provided an anti-theft immobilizer wherein the terminal actuator is provided inside the enclosure and is accessible through an enclosure aperture, the anti-theft immobilizer further comprising a door movable between door open and closed positions, wherein, in the door open position, the terminal actuator is accessible through the enclosure aperture, and, in the door closed position, the enclosure aperture is at least partially obstructed to prevent access to the terminal actuator from outside the enclosure.

There may also be provided an anti-theft immobilizer wherein the first terminal includes a clamp clampable to the first battery terminal, and wherein the terminal actuator includes a threaded fastener operable to selectively open and close the clamp relative to the first battery terminal.

There may also be provided an anti-theft immobilizer wherein the door includes a lever pivotable about a lever pivot and an obstructing member mounted to the lever opposed to the lever pivot, the obstructing member obstructing the enclosure aperture in the door closed position.

There may also be provided an anti-theft immobilizer further comprising a door actuator selectively activatable by the controller to move the door from the door open position to the door closed position.

There may also be provided an anti-theft immobilizer further comprising an intrusion sensor operative for sensing an intrusion into a vehicle compartment in which the anti-theft immobilizer is located, the controller being operative for energizing the door actuator to move the door to the door closed position when the intrusion sensor senses the intrusion.

There may also be provided an anti-theft immobilizer wherein the door actuator includes a shape memory alloy (SMA) element operable to close the door when heated using a closing electric current provided through the controller.

There may also be provided an anti-theft immobilizer wherein the onboard battery is provided in an engine bay accessible through a hood, the intrusion sensor being operative for detecting unauthorized access to the engine bay through opening of the hood.

There may also be provided an anti-theft immobilizer wherein the intrusion sensor includes a distance sensor operative for monitoring a sensor-to-hood distance between the intrusion sensor and the hood.

There may also be provided an anti-theft immobilizer wherein the intrusion sensor includes a light sensor operative for monitoring an increase in a light level in the engine bay caused by opening of the hood.

There may also be provided an anti-theft immobilizer wherein the intrusion sensor includes an antenna operative for monitoring an increase in radio-frequency radiation level at the anti-theft immobilizer in the engine bay caused by opening of the hood.

There may also be provided an anti-theft immobilizer wherein the intrusion sensor includes a telecommunication antenna usable for monitoring a reduction in capacitance between the telecommunication antenna and the hood caused by opening of the hood.

There may also be provided an anti-theft immobilizer wherein the theft sensor includes a current sensor for detecting an increase in current flowing through the switch above a predetermined current level.

There may also be provided an anti-theft immobilizer further comprising a speaker, the controller being operative for issuing an alarm through the speaker when a predetermined alarm criteria is met.

There may also be provided an anti-theft immobilizer further comprising a communication interface for communicating with a user-carried device, the controller automatically arming the anti-theft immobilizer when the communication interface indicates that the user-carried device is moved away from the vehicle beyond an arming distance, and the anti-theft immobilizer automatically disarming the anti-theft immobilizer when the user-carried device is closer to the vehicle than the arming distance.

In another broad aspect, there is provided a method of detecting unauthorized access to an engine bay, the method comprising: monitoring a bay variable using a sensor provided in the engine bay; upon detection of a predetermined change in the bay variable indicating access to the engine bay, issuing an alarm.

There may also be provided a method wherein the bay variable is selected from the group consisting of a distance between the sensor and a hood, a light level in the engine bay, a capacitance between a metallic component and a component of the engine bay and a radio-frequency radiation level in the engine bay.

Advantageously, the proposed immobilizer can be installed relatively quickly typically by most end users with the use of simple instructions, either written or in video format. Also, in some embodiments, the relatively easy installation and removal of the immobilizer that could facilitate inactivation by thieves is mitigated by intrusion detection systems that deter thieves once an engine bay is opened and that prevent removal of the immobilizer from the battery.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective environmental view, illustrates a vehicle immobilizer in accordance with an embodiment of the present invention installed in a vehicle;

FIG. 2, in a perspective view, illustrates the vehicle immobilizer of FIG. 1 secured to an onboard battery of the vehicle;

FIG. 3, in a perspective view, illustrates a vehicle immobilizer in accordance with an alternative embodiment of the present invention;

FIG. 4, in a perspective view with parts removed, illustrates internal components of the immobilizer of FIG. 3 with arm thereof in a first position and a door thereof in an open configuration;

FIG. 5, in a perspective view with parts removed, illustrates the internal components of FIG. 4 with the arm in a second position;

FIG. 6, in a perspective view with parts removed, illustrates some of the internal components of FIG. 3 with the door thereof in the open configuration;

FIG. 7, in a perspective view with parts removed, illustrates the internal components of FIG. 6 with the door in a closed configuration;

FIG. 8, in a schematic view, illustrates a digital controller present in some embodiments of the vehicle immobilizer of FIG. 3; and

FIG. 9, in a flowchart, illustrates a method performed by the digital controller of FIG. 8 to operate the vehicle immobilizer of FIG. 3.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

Terms such as “substantially”, “about” and “essentially” may be used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention. These variations are to be interpreted from the point of view of the person skilled in the art.

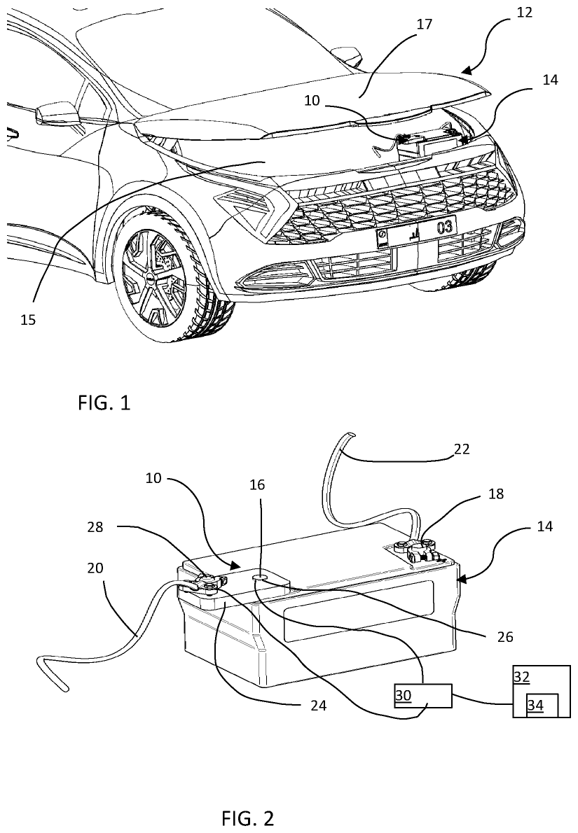

Referring to FIG. 1, there is shown an anti-theft immobilizer 10 for a vehicle 12, here shown as a car. However, similar anti-theft immobilizers 10 are usable with other types of vehicles, such as truck, earthmoving equipment, or boats, among other possibilities. To be used, the anti-theft immobilizer 10 requires a vehicle 12 having an onboard battery 14 that is required to start or operate the vehicle 12. For example, the onboard battery 14 is used to operate the engine starter or a combustion engine. However, in alternative embodiments, the onboard battery 14 is a low voltage (typically 12 V) battery used to power electronic components in an electric vehicle, as opposed to the relatively high voltage batteries used to power the electric motors of such electric vehicles.

The onboard battery 14 has first and second battery terminals 16 and 18, better seen in FIG. 2, usable to provide power to the vehicle 12 through first and second battery cables 20 and 22 when the latter are secured respectively to the first and second battery terminals 16 and 18 in a conventional manner (not shown in the drawings). The anti-theft immobilizer 10 slightly modifies this conventional arrangement as it is provided as an intermediary between the first battery terminal 16 and the first battery cable 20, so that the current supplied from the onboard battery 14 can be interrupted if required.

The anti-theft immobilizer 10 includes an enclosure 24, first and second immobilizer terminals 26 and 28, a switch 30 and a controller 32, these two last components being shown schematically in FIG. 2. The first immobilizer terminal 26 is typically provided at least in part or entirely inside the enclosure 24 and is usable for securing the anti-theft immobilizer 10 to the first battery terminal 16. The second immobilizer terminal 28 is provided outside of the enclosure 24 and is usable for securing the first battery cable 20 thereto. To that effect, the first immobilizer terminal 26 has a configuration similar to that of the free end of the first battery cable 20, and the second immobilizer terminal 28 has a configuration similar to the configuration of the first battery terminal 16. In a typical embodiment, the second immobilizer terminal 28 is substantially cylindrical, and the first immobilizer terminal 26 takes the form of a clamp or ring securable to a cylindrical first battery terminal 16. However, other shapes of the components used to make the above-described electrical connections are usable in alternative embodiment, and typically take the shape of conventional cable-to-battery connections used in the industry in which the anti-theft immobilizer 10 is used.

The switch 30 is provided between the first and second immobilizer terminals 26 and 28 and is configurable between open and closed configurations. In the closed configuration, the first and second immobilizer terminals 26 and 28 are electrically connected to each other so that an electric current can flow therebetween through the switch 30. In this configuration, the anti-theft immobilizer 10 acts as a short-circuit between the first and second immobilizer terminals 26 and 28. In the open configuration, the first and second immobilizer terminals 26 and 28 are electrically isolated from each other so that the electric current is prevented from flowing therebetween through the switch 30. In this configuration, the anti-theft immobilizer 10 acts as an insulator between the first and second immobilizer terminals 26 and 28. The switch 30 may take for example the form of an electronic switch, including one or more power transistors, or of a mechanical switch, for example in the form of a relay.

Operation of the switch 30 between the open and closed configurations is controlled by the controller 32. Different embodiments of the controller 32 can perform many different functions, some of which are further described below. The controller 32 typically includes a theft sensor 34 operative for detecting an attempted theft condition indicative of an attempted theft of the vehicle 12. Once such an attempted theft is detected, controller 32 is operable for selectively opening the switch 30 after the anti-theft immobilizer 10 has been armed.

Arming of the anti-theft immobilizer 10 requires a signal from a user of the anti-theft immobilizer 10 indicating that until the anti-theft immobilizer 10 is disarmed, any attempt to start the vehicle 12 is unintended, and should result in the anti-theft immobilizer 10 opening the switch 30. Such signals are for example provided using an app running on a cell phone, or in any other suitable manner. The controller 32 includes a network interface usable to communicate with the cell phone to monitor arming and disarming conditions. More details regarding arming and disarming are provided hereinbelow.

The theft sensor 34 is any sensor that has a capacity to detect an unauthorized attempt to start the engine or electric motor of the vehicle 12. For example, the theft sensor 34 includes a current sensor, for example a shunt resistor connected to suitable electronic components, monitoring a current passing through the switch 30. If this current becomes higher than a predetermined threshold, the relatively large current load indicates that, for example, the engine starter of the vehicle 12 has been activated. Typically, relatively low currents through the switch 30 should not trigger the immobilization response, as the electronic components of the vehicle 12 may require a small current draw from the onboard battery 14 even when the vehicle 12 is parked.

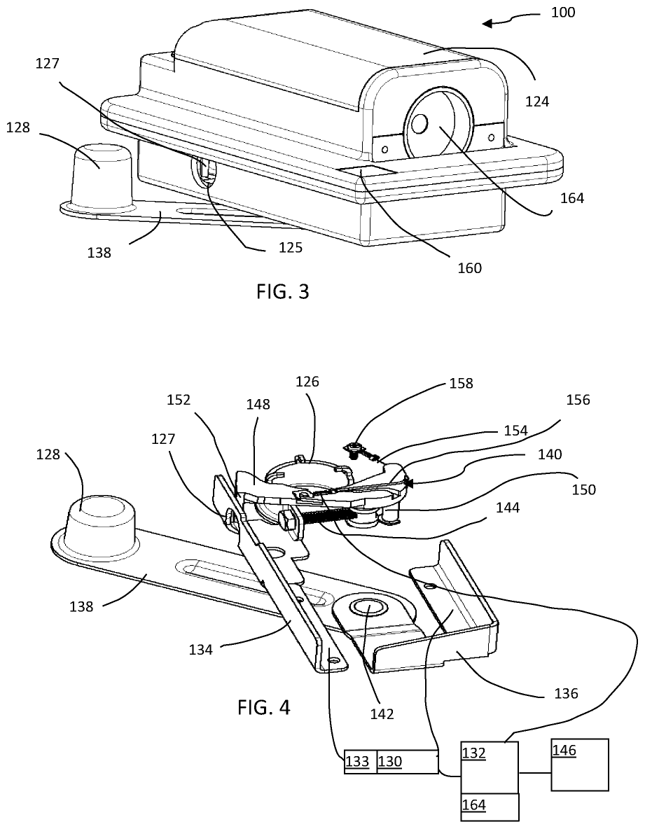

Referring collectively to FIGS. 3 to 5, there is shown an alternative anti-theft immobilizer 100 similar to the anti-theft immobilizer 10. The anti-theft immobilizer 100 is described in greater details than the anti-theft immobilizer 10. Most of the functionalities and structures described below with respect to the anti-theft immobilizer 100 could also be implemented in the anti-theft immobilizer 10.

The anti-theft immobilizer 100 includes an enclosure 124, first and second immobilizer terminals 126 and 128, a switch 130, a controller 132 and a theft sensor 133, all having functions similar to the like named components in the anti-theft immobilizer 10. The enclosure 124 defines an enclosure aperture 125 leading thereinto. One difference between the anti-theft immobilizer 10 and the anti-theft immobilizer 100 resides in that the second immobilizer terminal 128 is pivotable at least part way around the enclosure 124, which helps with installations in vehicles 10 having different onboard battery 14 positions and orientations.

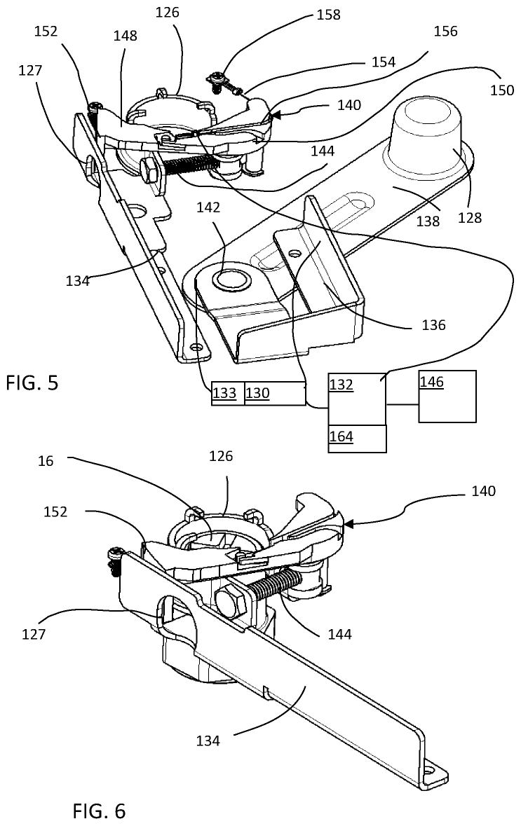

This functionality is better understood with respect to FIGS. 4 and 5, in which the enclosure 124 has been removed to show internal components of the anti-theft immobilizer 100. These components include the first and second immobilizer terminals 126 and 128, and in addition, first and second busbars 134 and 136, an arm 138 and a door 140. The first and second busbars 134 and 136 are metallic members electrically connected respectively to the first and second immobilizer terminals 126 and 128, but separated from each other by an air gap, so that current cannot flow directly therebetween. The switch 130 extends between the first and second busbars 134 and 136, and therefore controls current flow between the first and second immobilizer terminals 126 and 128. The switch 130 is shown only schematically in the drawings. It may take for example the form of a printed circuit board (PCB) on which power transistors are located, and which is electrically connected to the first and second busbars 134 and 136. The controller 132 is electrically connected to the switch 130 so as to control its open and closed configurations in a conventional manner.

The controller 132 and/or the switch 130 may be powered by the onboard battery 14 if a suitable lead is installed. It has been found advantageous in some embodiments to instead have the anti-theft immobilizer 100 electrically disconnected from the second battery terminal 18, and to include an immobilizer power source 146 distinct from the onboard battery 14 for powering the anti-theft immobilizer 100, and more specifically, the controller 132 and/or the switch 130. This simplifies installation of the anti-theft immobilizer 100 in the vehicle 12, and also improves resistance to tampering by thieves who would like to disable the anti-theft immobilizer 100, which could be relatively easy to do if the lead to the second battery terminal 18 were cut.

The arm 138 is typically substantially elongated and made of an electrically conductive material. The arm 138 is electrically connected to the second busbar 136 and mounted thereto so as to be pivotable relative thereto through a pivot 142 extending through the enclosure 124. The second immobilizer terminal 128 extends from the arm 138 opposed longitudinally to the pivot 142, and may take the form of a generally cylindrical peg extending integrally from the remainder of the arm 138. By pivoting the arm 138 about the pivot 142, as seen when comparing FIGS. 4 and 5 to each other, one can change the position of the second immobilizer terminal 128 to accommodate various onboard battery 14 positions, orientations and configurations. Typically, the arm 138 is positioned relative to the enclosure 124 such that it is provided at least in part between the onboard battery 14 and the enclosure 124 when the anti-theft immobilizer 100 is secured to the onboard battery 14.

The first immobilizer terminal 126 may take the form for example of a resiliently deformable C-shaped clamp sized to receive the first battery terminal 16 thereinto. The first immobilizer terminal 126 is configurable between terminal locked and unlocked configurations in which the first immobilizer terminal is respectively locked to and removable from the battery terminal. In the embodiment shown in the drawings, the locking and unlocking actions are performed by tightening or loosening the first immobilizer terminal 126 onto or from the first battery terminal 16.

This action is performed through a terminal actuator 144 that allows an intended user to move the first immobilizer terminal 126 between the terminal locked and unlocked configurations. For example, the terminal actuator 144 takes the form of a threaded fastener extending across the open gap of a C-shaped first immobilizer terminal 126 and engaging the latter so that rotating the threaded fastener tightens or loosens the first immobilizer terminal 126 onto or from the first battery terminal 16. The terminal actuator 144 is located inside the enclosure 124, and is accessible through the enclosure aperture 125, and in the embodiment shown in the drawings, through a busbar aperture 127 formed in the first busbar 134 and located in register with the enclosure aperture 125. In the embodiment shown in the drawings, the threaded fastener has a fastener head facing the enclosure aperture 125. This position and configuration of the terminal actuator 144 simplifies mechanically the anti-theft immobilizer 100, while being advantageous when anti-tampering functionalities, described further below, are implemented.

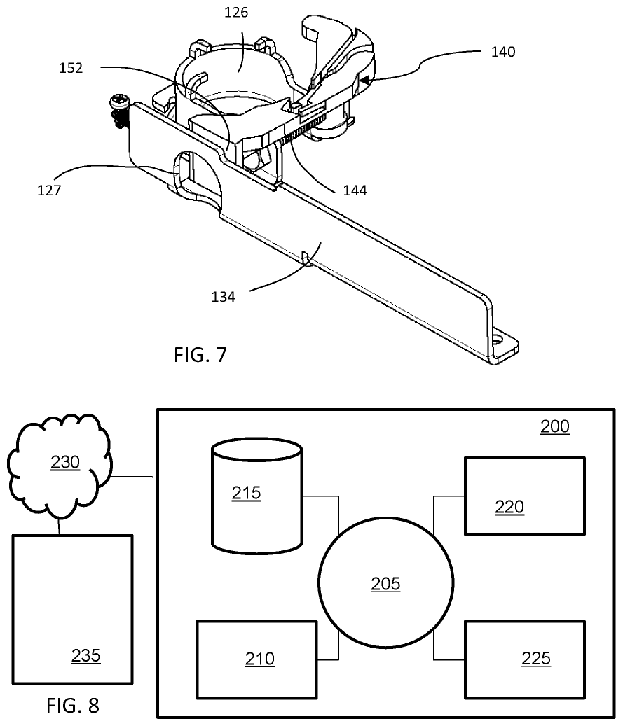

The door 140 is located inside the enclosure 124 and is movable between door open and closed positions, seen respectively in FIGS. 6 and 7. In the door open position, the terminal actuator 144 is accessible through the enclosure aperture 125 and bus bar aperture 127. In the door closed position, the enclosure aperture 125 is at least partially obstructed to prevent access to the terminal actuator from outside the enclosure. This can be performed, as illustrated in the drawings, by blocking the busbar aperture 127 with the door 140.

The door 140 includes a lever 148 pivotable about a lever pivot 150 and an obstructing member 152 mounted to the lever 148 opposed to the lever pivot 150. The obstructing member 152 is configured and sized to completely or partially obstruct the enclosure aperture 125 in the door closed position, and may take the form for example of a plate. Typically, the obstructing member 152 is larger than the enclosure aperture 125 so as to completely obstruct the latter when the door 140 is closed and prevent insertion of a tool in a gap left by the obstructing member that could be used for opening of the door 140.

The door 140 moves from the door open position to the door closed positions through a door actuator 154 selectively activatable by the controller 132. For example, the door actuator 154 takes the form of a shape memory alloy (SMA) element operable to close the door 140 when heated using a closing electric current provided through the controller 132. To that effect, the SMA element may be an elongated wire received in a suitably shaped groove 156 formed in the lever 148 and connected to the enclosure 124 through an anchor 158. The SMA element has been preformed so that when cold, below the transformation temperature of the SMA element, the door 140 is in the open configuration. When a suitable current passes through the SMA element, the latter is heated through ohmic heating and changes shape to a shape causing the door to pivot relative to the pivot 150 to achieve the door closed configuration. One notes that only a relatively small current may be required to achieve this change in shape, as the SMA element can be relatively thin, and therefore exhibit a relatively high electrical resistance. Also, the increase in temperature may be relatively modest.

Activation of the door actuator 154 to close the door 140 can be performed by the controller 132 under numerous conditions, depending on the embodiment. In a first embodiment, this door closes automatically when the anti-theft immobilizer 100 is armed. This has a disadvantage that the immobilizer power source 146, when present, will become relatively quickly depleted. To mitigate this problem, the door actuator 154 can be closed only when needed, when there is a suspected attempt to steal the vehicle 12 or to tamper with the immobilizer function of the anti-theft immobilizer 100. For example, at any time the switch 130 is closed, the door actuator 154 may close the door 140.

In another example, the anti-theft immobilizer 100 includes an intrusion sensor 160 (seen in FIG. 3) for sensing an intrusion condition indicative of an intrusion into a vehicle compartment 15 in which the anti-theft immobilizer 100 is located. In the case of a car having a combustion engine, the vehicle compartment 15 is typically the engine bay of the vehicle 12, but in other embodiments, the vehicle compartment 15 is any enclosed space in which the onboard battery 14 is located. The controller 132 is operative for energizing the door actuator 154 to move the door 140 to the door closed position when the intrusion sensor 160 senses the intrusion. Closing the door 140 therefore prevents access to the actuator 144, so that even after having gained access to the vehicle compartment 15, a thief cannot remove the anti-theft immobilizer 100 from the onboard battery 14. Intrusion is typically sensed through opening of an access allowing access to the interior of the vehicle compartment 15. In the case of a combustion engine car, for example, this access is detected through opening of the hood 17 of the vehicle 12. In some embodiments, the door 140 is closed only after the switch 130 has been opened due to an unauthorized attempt to start the vehicle 12. In other embodiments, the door 140 can be closed at any time after the anti-theft immobilizer 100 has been armed.

The intrusion sensor 160 can take many forms. In a first embodiment, the intrusion sensor 160 takes the form of a distance sensor operative for monitoring a sensor-to-hood distance between the intrusion sensor 160 and the hood 17, or a similar access. For example, the distance sensor 160 includes an ultrasound sensor positioned on the anti-theft immobilizer 100 so as to face the hood 17 when the anti-theft immobilizer 100 is operatively installed in the vehicle compartment 15. By monitoring the time of flight of ultrasounds between the intrusion sensor 160 and the hood 17, the controller 132 can detect unauthorized opening of the hood 17 when this time of flight increases beyond a predetermined value, or when there is no longer a reflected signal detected.

In another embodiment, the intrusion sensor 160 includes a light sensor, for example a photodiode, operative for monitoring an increased light level in the vehicle compartment 15 caused by opening of the hood 17. Indeed, due either to daylight or to artificial light, when the hood 17 is opened to tamper with the anti-theft immobilizer 100, there will typically be a sudden increase in illumination in the vehicle compartment 15. If the light level detected by the intrusion sensor 160 increases at a rate larger than a predetermined rate, it is assumed that there was an intrusion, as light levels due to natural changes in illumination around the vehicle 12 will typically be more gradual.

In yet another embodiment, the intrusion sensor 160 includes an antenna operative for monitoring an increase in radio-frequency radiation level at the anti-theft immobilizer in the engine bay 15 caused by opening of the hood 17. Indeed, the vehicle 12 often has a metallic body, which shields the interior of the engine bay 15 from ambient electromagnetic radiation. A sudden increase in the level of such radiations can indicate that the hood 17 has been opened.

In yet another embodiment, the intrusion sensor 160 includes a metallic component used to monitor the changes in capacitance between this metallic component and the typically metallic body and hood 17 of the vehicle 12 that is created when the hood 17 is opened. In a specific embodiment, this metallic component is a telecommunication antenna used to communicate with a cell phone network, further described below. Indeed, when this antenna is not used for communications, it can be repurposed to serve as one plate (or electrode) of a capacitor formed by the antenna and the surrounding metallic components of the vehicle 12. By detecting changes in capacitance between this antenna and these surrounding metallic components, one can detect when these metallic components move, which can indicate that the hood 17 has been opened. Advantageously, this antenna can be either used alone, or in combination with any of the other intrusion sensors 160 described herein and, in some embodiments, adds no significant costs to the anti-theft immobilizer 100, as it is already present in the device, and the capacitance monitoring circuitry can be added at a relatively low cost.

The intrusion sensor may include more than one of the above-mentioned types of sensors, or any other suitable sensor usable to detect unauthorized access to the vehicle compartment 15.

In some embodiments, the anti-theft immobilizer 100, further includes a speaker 164 and the controller 132 is operative for issuing an alarm through the speaker 164 when a predetermined alarm criteria is met. The alarm is typically a relatively loud repetitive noise. For example, the predetermined alarm criteria is detection of the intrusion in the vehicle compartment 15, but alarms may be issued under other conditions.

The controller 132 is now described in greater details with reference to FIG. 8. The controller 132 includes for example a digital controller 200 that is programmed or otherwise configured to operate the anti-theft immobilizer 100.

The digital controller 200 includes a central processing unit (CPU, also “processor” and “computer processor” herein) 205, which can be a single core or multi core processor, or a plurality of processors for parallel processing. The CPU 205 may also be part of a microcontroller. The digital controller 200 also includes memory or memory location 210 (e.g., random-access memory, read-only memory, flash memory), optionally an electronic storage unit 215 (e.g., hard disk), a communication interface 220 for communicating with one or more other systems, and an interface 225 for controlling the switch 130 and receiving data from the theft and intrusion and sensors 133 and 160. The memory 210, storage unit 215, communication interface 220 and interface 225 are in communication with the CPU 205 through a communication bus (solid lines). The storage unit 215 can be a data storage unit (or data repository) for storing data. The digital controller 200 can be operatively coupled to a network (“network”) 230 with the aid of the communication interface 220. The network 230 can be the Internet, or an intranet and/or extranet that is in communication with the Internet. The network 230 in some cases is a telecommunication and/or data network. The network can also be a more limited network, such a Bluetooth network. The network 230, in some cases with the aid of the digital controller 200, can implement a peer-to-peer network, which may enable devices coupled to the digital controller 200 to behave as a client or a server. The network 230 can also be in in communication with a control device 235 used to control the controller 132. For example, the control device 235 is a smart phone owned by the owner of the vehicle 12.

The CPU 205 can execute a sequence of machine-readable instructions, which can be embodied in a program or software. The instructions may be stored in a memory location, such as the memory 210. The instructions can be directed to the CPU 205, which can subsequently program or otherwise configure the CPU 205 to implement methods of the present disclosure. Examples of operations performed by the CPU 205 can include fetch, decode, execute, and writeback. The CPU 205 can be part of a circuit, such as an integrated circuit. One or more other components of the digital controller 200 can be included in the circuit. In some cases, the circuit is an application specific integrated circuit (ASIC).

The storage unit 215 can store files, such as drivers, libraries and saved programs. The storage unit 215 can store user data, e.g., user preferences and user programs. The digital controller 200 in some cases can include one or more additional data storage units that are external to the digital controller 200, such as located on a remote server that is in communication with the digital controller 200 through an intranet or the Internet.

In some embodiments, the digital controller 200 can communicate with one or more remote computer systems through the network 230. The digital controller 200 is also operative for communicating with electrical components of the anti-theft immobilizer 100. For example, the interface 225 includes a module interface including the required control logic and power control components required to operate the switch 130 and receive relevant data from the theft and intrusion and sensors 133 and 160. This dedicated interface may be provided in a separate device connected to the remainder of the digital controller 200 through an interface, for example and non-limitingly a USB bus, or be an integral part of the digital controller 200. The user can, in some embodiments, access the digital controller 200 via the network 230.

Control of the anti-theft immobilizer 100 is affected through executable code stored on an electronic storage location of the digital controller 200, such as, for example, on the memory 210 or electronic storage unit 215. The machine executable or machine-readable code can be provided in the form of software. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210.

The code can be pre-compiled and configured for use with a machine having a processor adapted to execute the code, or can be compiled during runtime. The code can be supplied in a programming language that can be selected to enable the code to execute in a pre-compiled or as-compiled fashion. The code may provide a user interface allowing commands to be entered, and a control module controlling the dedicated interface, for example in the form of a device driver.

Aspects of the digital controller 200 can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In some embodiments, the digital controller 200 communicates with the control device 235 through a Bluetooth protocol. Such protocol has a relatively small range. As such, once the control device 235 moves beyond a relatively small arming distance from the digital controller 200, the communication signal is lost or falls below a predetermined threshold. This can be used to indicate that the user of the vehicle 12 has left the vicinity of the vehicle 12, and that, consequently, the anti-theft immobilizer 100 should be armed. In such cases, once the digital controller 200 determines that the arming distance has been reached, the anti-theft immobilizer 100 can be automatically armed by the digital controller 200. Instead of, or in addition to the automatic determination that the anti-theft immobilizer 100 should armed, the control device 235 can run an app that allows sending an arming signal through the network 230 to indicate to the digital controller 200 that the anti-theft immobilizer 100 should be armed. The arming distance is not necessarily a fixed distance, and may depend on the electromagnetic environment adjacent the vehicle 12.

Disarming of the anti-theft immobilizer 100 is performed by the opposite of the previous steps, that is by either indicating through the app that disarming should be performed by the digital controller 200, or by detecting presence of the control device 235 automatically to automatically disarm the anti-theft immobilizer 100.

In some embodiments, the control device 235 or the controller 132 is provided with a positioning system usable to determine a position of the personal device or of the controller 132. For example, the positioning system is a Global Positioning System (GPS) device. The positioning system can be used to indicate that the vehicle 12 is in proximity to a service facility when comparing the position of the control device 235 or controller 132 with a database of known service facilities, so that the user of the vehicle can be warned that the vehicle 12 is likely to be brought for service, and that the anti-theft immobilizer 100 should therefore be disarmed manually, so that it stays disarmed even when communication with the control device 235 is lost. Such warning can be provided for example in the form of a notification on the control device 235 or of a SMS message.

In some embodiments, the anti-theft immobilizer 100 is also usable to monitor the health of the onboard battery 14. Indeed, such onboard batteries 14 typically degrade slowly over time, which can lead to an inoperable onboard battery 14, that is unable to provide the current required to start the vehicle 12. By monitoring the response of the onboard battery 14 when the vehicle 12 is started, or by monitoring the voltage across the first and second battery terminals 16 and 18, degradation of the onboard battery 14 can be monitored, and an alarm can be issued by the digital controller 200 to the control device 235 when this degradation becomes critical, so that there is a likelihood that the vehicle 12 will be unable to start in the near future.

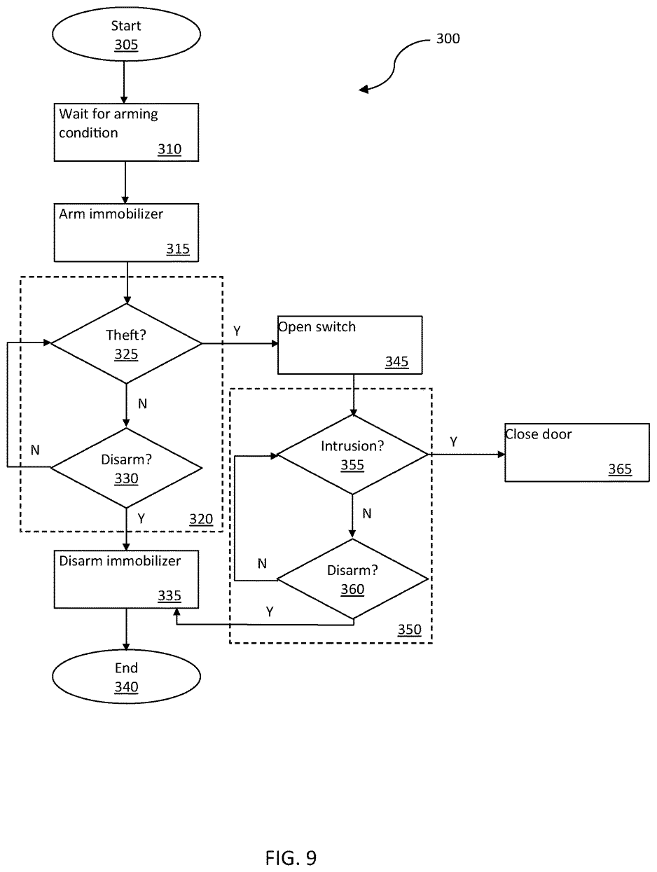

An example of a method 300 of operation of the anti-theft immobilizer 100 through the controller 132 is now described with reference to FIG. 9. One presumes that initially, the vehicle 12 is driven and approaches a location where it will be left unattended, when the method starts at step 305. Then, the vehicle 12 is parked, and its engine is turned off. At step 310 the anti-theft immobilizer 100 continuously monitors the network 230 for the presence of the control device 235 until the control device 235 is no longer detected, at which point the anti-theft immobilizer 100 is armed at step 315. Arming is typically performed by changing the state of software running on the digital controller 200 so that a monitoring loop 320 is entered. The monitoring loop 320 periodically assesses successively whether one of two conditions is met, namely the attempted theft condition and the disarming condition at steps 325 and 330 respectively.

If the disarming condition is met at step 330, the monitoring loop 320 is exited and the anti-theft immobilizer 100 is disarmed at step 335, after which the method 300 ends at step 340. The vehicle 12 can then be operated in a conventional manner without interference from the anti-theft immobilizer 100.

If attempted theft condition is met at step 325, the monitoring loop 320 is exited and the method jumps to step 345 during which the controller 132 opens the switch 130, which renders the vehicle 12 inoperable. Then, an intrusion loop 350 is performed at steps 355 and 360 successively to determine if the intrusion condition or the disarming conditions are met, respectively. If the intrusion sensor 160 signals that the intrusion condition has been met, for example if a thief wishes to investigate the cause of the vehicle 12 not starting, the method jumps to step 365, and the controller 132 closes the door 140, and, in some embodiments, uses the speaker 164 to issue an alarm. The alarm may run for a predetermined amount of time, or be only disabled by the user using the control device 235. If the disarming condition is met, the method jumps to step 335 as described above. Once the door has been closed, the method may end, or monitoring for the disarming condition may continue.

In some embodiments, in addition to performing the above-described functionalities, the digital controller 200 is configured to send messages to the control device 235 when the intrusion and/or attempted theft conditions are met, for example as SMS messages through a cellular phone network. These messages would for example be sent at steps 345 or 365.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

1. An anti-theft immobilizer for a vehicle, the vehicle including an onboard battery having first and second battery terminals usable to provide power to the vehicle through first and second battery cables when the latter are secured respectively to the first and second battery terminals, the anti-theft immobilizer comprising:
an enclosure;
a first immobilizer terminal provided inside the enclosure for securing the anti-theft immobilizer to the first battery terminal;
a second immobilizer terminal provided outside of the enclosure for securing the first battery cable thereto;
a switch between the first and second immobilizer terminals and configurable between open and closed configurations, wherein, in the closed configuration, the first and second immobilizer terminals are electrically connected to each other so that an electric current can flow therebetween through the switch, and, in the open configuration, the first and second immobilizer terminals are electrically isolated from each other so that the electric current is prevented from flowing therebetween through the switch; and
a controller for configuring the switch between the open and closed configurations, the controller including a theft sensor operative for detecting an attempted theft of the vehicle, the controller being operable for selectively opening the switch when the attempted theft is detected by the theft sensor after the anti-theft immobilizer has been armed;
wherein, in operation, the anti-theft immobilizer is provided as an intermediary between the first battery terminal and the first battery cable.

2. The anti-theft immobilizer as defined in claim 1, wherein the anti-theft immobilizer is electrically disconnected from the second battery terminal and includes an immobilizer power source distinct from the onboard battery for powering the anti-theft immobilizer.

3. The anti-theft immobilizer as defined in claim 1, wherein the second immobilizer terminal is pivotable at least part way around the enclosure.

4. The anti-theft immobilizer as defined in claim 1, wherein the first immobilizer terminal is configurable between terminal locked and unlocked configurations in which the first immobilizer terminal is respectively locked to and removable from the first battery terminal.

5. The anti-theft immobilizer as defined in claim 4, wherein the first immobilizer terminal includes a terminal actuator for selectively moving the first immobilizer terminal between the terminal locked and unlocked configurations.

6. The anti-theft immobilizer as defined in claim 5, wherein the terminal actuator is provided inside the enclosure and is accessible through an enclosure aperture, the anti-theft immobilizer further comprising a door movable between door open and closed positions, wherein, in the door open position, the terminal actuator is accessible through the enclosure aperture, and, in the door closed position, the enclosure aperture is at least partially obstructed to prevent access to the terminal actuator from outside the enclosure.

7. The anti-theft immobilizer as defined in claim 6, wherein the first terminal includes a clamp clampable to the first battery terminal, and wherein the terminal actuator includes a threaded fastener operable to selectively open and close the clamp relative to the first battery terminal.

8. The anti-theft immobilizer as defined in claim 6, wherein the door includes a lever pivotable about a lever pivot and an obstructing member mounted to the lever opposed to the lever pivot, the obstructing member obstructing the enclosure aperture in the door closed position.

9. The anti-theft immobilizer as defined in claim 8, further comprising a door actuator selectively activatable by the controller to move the door from the door open position to the door closed position.

10. The anti-theft immobilizer as defined in claim 9, further comprising an intrusion sensor operative for sensing an intrusion into a vehicle compartment in which the anti-theft immobilizer is located, the controller being operative for energizing the door actuator to move the door to the door closed position when the intrusion sensor senses the intrusion.

11. The anti-theft immobilizer as defined in claim 10, wherein the door actuator includes a shape memory alloy (SMA) element operable to close the door when heated using a closing electric current provided through the controller.

12. The anti-theft immobilizer as defined in claim 10, wherein the onboard battery is provided in an engine bay accessible through a hood, the intrusion sensor being operative for detecting unauthorized access to the engine bay through opening of the hood.

13. The anti-theft immobilizer as defined in claim 12, wherein the intrusion sensor includes a distance sensor operative for monitoring a sensor-to-hood distance between the intrusion sensor and the hood.

14. The anti-theft immobilizer as defined in claim 12, wherein the intrusion sensor includes a light sensor operative for monitoring an increase in a light level in the engine bay caused by opening of the hood.

15. The anti-theft immobilizer as defined in claim 12, wherein the intrusion sensor includes an antenna operative for monitoring an increase in radio-frequency radiation level at the anti-theft immobilizer in the engine bay caused by opening of the hood.

16. The anti-theft immobilizer as defined in claim 12, wherein the intrusion sensor includes a telecommunication antenna usable for monitoring a reduction in capacitance between the telecommunication antenna and the hood caused by opening of the hood.

17. The anti-theft immobilizer as defined in claim 1, wherein the theft sensor includes a current sensor for detecting an increase in current flowing through the switch above a predetermined current level.

18. The anti-theft immobilizer as defined in claim 1, further comprising a speaker, the controller being operative for issuing an alarm through the speaker when a predetermined alarm criteria is met.

19. The anti-theft immobilizer as defined in claim 1, further comprising a communication interface for communicating with a user-carried device, the controller automatically arming the anti-theft immobilizer when the communication interface indicates that the user-carried device is moved away from the vehicle beyond an arming distance, and the anti-theft immobilizer automatically disarming the anti-theft immobilizer when the user-carried device is closer to the vehicle than the arming distance.

20. A method of detecting unauthorized access to an engine bay, the method comprising:
monitoring a bay variable using a sensor provided in the engine bay;
upon detection of a predetermined change in the bay variable indicating access to the engine bay, issuing an alarm.

21. The method as defined in claim 20, wherein the bay variable is selected from the group consisting of a distance between the sensor and a hood, a light level in the engine bay, a capacitance between a metallic component and a component of the engine bay and a radio-frequency radiation level in the engine bay.
